(19) United States
(12) Patent Application Publication
(10) Pub. No.: US 2024/0316522 A1
(43) Pub. Date: Sep. 26, 2024

(54) PLATE GRID DISTRIBUTORS AND METHODS OF USING THE SAME

(71) Applicant: Dow Global Technologies LLC, Midland, MI (US)

(72) Inventors: Matthew T. Pretz, Freeport, TX (US); Donald F. Shaw, Forked River, NJ (US); Richard E. Walter, Long Valley, NJ (US); Albert Meza, Houston, TX (US); Fermin Sandoval, Houston, TX (US); Liwei Li, Freeport, TX (US)

(73) Assignee: Dow Global Technologies LLC, Midland, MI (US)

(21) Appl. No.: 18/573,165

(22) PCT Filed: Jun. 24, 2022
(86) PCT No.: PCT/US2022/034843

§ 371 Date: Dec. 21, 2023

Related U.S. Application Data
(60) Provisional application No. 63/216,768, filed on Jun. 30, 2021.

(51) Int. Cl. B01J 8/44

(52) U.S. Cl. CPC B01J 8/44; B01J 2208/00884; B01J 2208/0092; B01J 2208/00938

(57) ABSTRACT

According to one or more embodiments, a plate grid distributor for distributing a fluid in a vessel may include a plate and an internal support system. The internal support system may include a plurality of pillar supports extending vertically from at or near a bottom surface of the plate towards a floor of the vessel. One or more of the pillar supports may include a flexible upper member connecting a rigid top support bracket to a rigid intermediate beam and a flexible lower member connecting the rigid intermediate beam to the rigid base support. According to one or more other embodiments, a method of distributing a fluid through a plate grid distributor in a vessel may include passing the fluid into the vessel below the plate grid distributor and directing the fluid through the plate gird distributor.

### CROSS-REFERENCE TO RELATED APPLICATIONS

The present application is a PCT application claiming priority to U.S. Provisional Patent Application No. 63/216,768, filed Jun. 30, 2021, and entitled “PLATE GRID DISTRIBUTORS AND METHODS OF USING THE SAME.” the contents of which are incorporated in their entirety herein.

### TECHNICAL FIELD

The present specification generally relates chemical processing and, more specifically, to systems and methods for distributing a fluid through a distributor.

### BACKGROUND

Gaseous chemicals may be fed into reactors or other vessels through distributors. Distributors may be utilized to promote balanced distribution of a feed chemical stream into such reactors or vessels. Such distribution of feed chemicals may promote preferred reactions and may maintain mass transport equilibriums in chemical systems.

### SUMMARY

In a number of chemical processes, chemical feed streams are fed through plate gird distributors into a hot environment, such as a reactor or other vessels. With increasing reactor or vessel sizes, additional mechanical supports may be needed to help support the plate grid distributors. Further, these hot environments may elevate the temperature of the plate grid distributors, such as a plate of the plate grid distributor. As temperatures of the plate grid distributors may elevate, the plate may thermally expand outwards towards outer walls of the reactors or other vessels. This is particularly problematic in fluidized bed vessels, where the hot environment may cause the plate of the plate grid distributor to thermally expand and contract. In turn, thermal expansion and contraction of the plate may raise difficulties in supporting the plate of the plate grid distributor. Accordingly, there is an on-going need for improved plate grid distributors. It has been found that plate grid distributors with an internal support system may provide adequate support for plates of plate grid distributors while meeting the needs of supporting the plate during the thermal expansion and contraction of the plate. Embodiments of such plate grid distributors are described herein. Embodiments of the present disclosure meet this need by utilizing internal support systems that are able to bend during the thermal expansion and contraction of the plate such that the internal support systems may continue to provide support during said thermal expansion and contraction of the plate.

According to one embodiment, a plate grid distributor for distributing a fluid in a vessel may include a plate and an internal support system. The plate may include a plurality of apertures. The plate may include a top surface and a bottom surface opposite the top surface. The internal support system may be in direct contact with the bottom surface of the plate. The internal support system may include a plurality of pillar supports extending substantially vertically from at or near the bottom surface of the plate towards a floor of the vessel. One or more of the pillar supports may include a rigid top support bracket, a rigid intermediate beam, a rigid base support bracket attached to the floor of the vessel, a flexible upper member connecting the rigid top support bracket to the rigid intermediate beam, and a flexible lower member connecting the rigid intermediate beam to the rigid base support. The flexible upper member and flexible lower member may bend when the plate thermally expands or contracts allowing for the angle from vertical of the rigid intermediate beam to change.

According to another embodiment, a method of distributing a fluid through a plate grid distributor in a vessel may include passing the fluid into the vessel at reaction conditions through a fluid inlet below the plate grid distributor and directing the fluid through the plate grid distributor. The plate grid distributor may include a plate and an internal support system. The plate may include a plurality of apertures. The plate may include a top surface and a bottom surface opposite the top surface. The internal support system may be in contact with the bottom surface of the plate. The internal support system may include a plurality of pillar supports extending substantially vertically from at or near the bottom surface of the plate towards a floor of the vessel. One or more of the pillar supports may include a rigid top support bracket, a rigid intermediate beam, a rigid base support bracket attached to the floor of the vessel, a flexible upper member connecting the rigid top support bracket to the rigid intermediate beam, and a flexible lower member connecting the rigid intermediate beam to the rigid base support. The flexible upper member and flexible lower member bend when the plate thermally expands or contracts allowing for the angle from vertical of the rigid intermediate beam to change.

Additional features and advantages will be set forth in the detailed description which follows, and in part will be readily apparent to those skilled in the art from that description or recognized by practicing the embodiments described herein, including the detailed description which follows and the claims.

It is to be understood that both the foregoing general description and the following detailed description describe various embodiments and are intended to provide an overview or framework for understanding the nature and character of the claimed subject matter.

### BRIEF DESCRIPTION OF THE DRAWINGS

FIG. 1 is a schematic illustration of a cross-sectional view of a vessel and plate grid distributor, in accordance with one or more embodiments of the present disclosure;

FIG. 2 is a schematic illustration of a plate grid distributor and internal support system, in accordance with one or more embodiments of the present disclosure;

FIG. 3A is a schematic illustration of a rigid top support bracket of a pillar support of an internal support system, in accordance with one or more embodiments of the present disclosure;

FIG. 3B is a schematic illustration of a rigid intermediate beam of a pillar support of an internal support system, in accordance with one or more embodiments of the present disclosure;

FIG. 3C is a schematic illustration of a rigid base support bracket of a pillar support of an internal support system, in accordance with one or more embodiments of the present disclosure; and

FIG. 3D is a schematic illustration of a flexible upper member or a flexible lower member of a pillar support of an internal support system, in accordance with one or more embodiments of the present disclosure.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

The present disclosure is directed, according to one or more embodiments described herein, towards plate grid distributors and methods for using such. Generally, the plate grid distributors described herein may comprise a plate and an internal support system. The plate grid distributors described herein may be used for distributing a fluid in a vessel. The vessel may include a gaseous feed conduit that may be distributed in the vessel by the plate grid distributor. Generally, the plate distributors described herein comprise an internal support system that may help support the plate. In some embodiments, such an internal support system may be needed in addition to a skirt, which may provide support around the perimeter of the plate. As chemical processes proceed in the vessel, the plate may thermally expand due to the reaction conditions. The internal support system may include a plurality pillar supports that are able to bend as the plate thermally expands and to continue to support the plate as chemical processes proceed in the vessel at elevated temperatures.

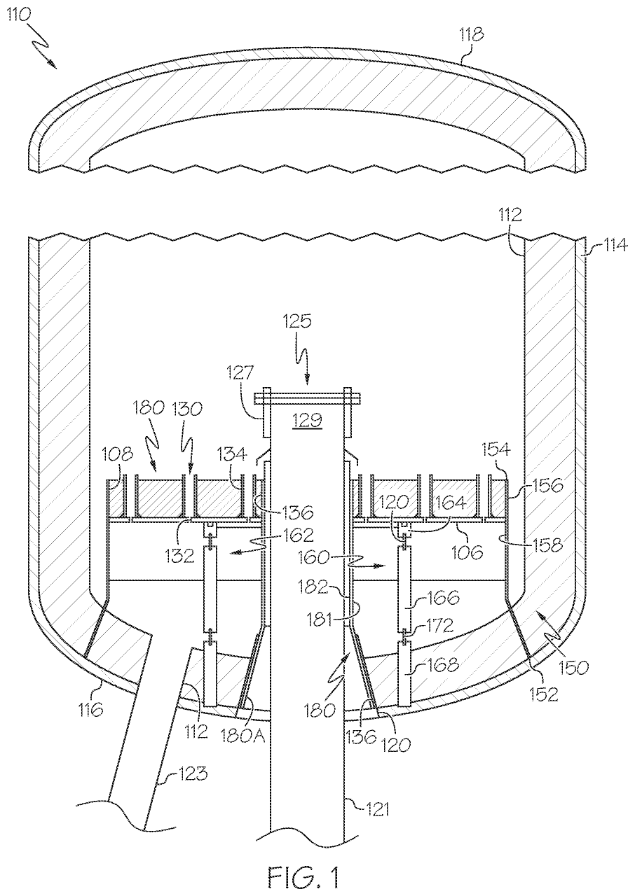

Referring now to FIG. 1, the plate grid distributors 100 of the present disclosure may be positioned in a vessel 110. The vessel 110 may have various configurations. The vessel 110 may include one or more polyhedron, sphere, cylinder, cone, irregular shape, combinations thereof, and/or portions thereof. For example, the vessel 110 may include a right hollow cylinder with a longitudinal axis. The vessel 110 may include a refractory-lined inner wall 112, an outer wall 114, a floor 116, a top 118, a catalyst feed conduit receiving passageway 120, and a gaseous feed conduit receiving passageway 122.

According to one or more embodiments, the plate grid distributor 100 for distributing a fluid in a vessel 110 may comprise a plate 102. The plate may comprise a top surface 104 and a bottom surface 106. The bottom surface 106 may be opposite the top surface 104 and may be spaced apart from the top surface 104. The plate 102 may comprise an outer surface 108. The outer surface 108 may have a portion that is normal to the top surface 104 and the bottom surface 106. The outer surface 108 can be welded to the top surface 104 and/or bottom surface 106. The plate 102 may have an average diameter from greater than or equal to 5 feet (1.5 meters (m)) to less than or equal to 75 feet (22.9 m), such as from greater than or equal to 10 feet (3.0 m) to less than or equal to 50 feet (15.2 m). The plate 102 may be substantially planar (i.e., the top surface 104 and the bottom surface 106 may be substantially parallel). However, it is contemplated that in additional embodiments, the plate 102 may be non-planar.

The bottom surface 106, the top surface 104, or both of the plate 102 may be refractory-lined. Additionally or alternatively, other materials with insulating properties (e.g., insulating material) may be disposed between the bottom surface 106 and the top surface 104 of the plate 102. The refractory lining, the insulating material, or both may help prevent the bottom surface 106 of the plate 102 from heating.

The plate 102 may comprise a plurality of apertures 130. Each of the plurality of apertures 130 may be in fluid communication with the bottom surface 106 of the plate 102 and the top surface 104 of the plate 102 via first aperture portions 132 and second aperture portions 134. The plurality of apertures 130 may be even with (i.e., not extend further than) the top surface 104 and/or the bottom surface 106. Alternatively, the plurality of apertures 130 may extend past (i.e., below) the bottom surface 106 and/or past (i.e., above) the top surface 104. The plurality of apertures 130 may comprise a lip that extend past the bottom surface 106, the top surface 104, or both. The second aperture portions 134 may have a greater cross-sectional area than the first aperture portions 132.

The first aperture portions 132 and the second aperture portions 134 of the plate 102 may have uniform or varying cross-sectional areas to help provide that an even distribution of gas passes through each of the plurality of apertures 130. For instance, first aperture portions 132 that are nearer to gaseous feed conduit may have a greater pressure difference between the bottom surface 106 and the top surface 104 of the plate 102. As such, first aperture portions 132 of the plate 102 that are nearer to the gaseous feed conduit can have a smaller cross-sectional area than first aperture portions 132 that are further from the gaseous feed conduit to help equilibrate a pressure differential across the plate 102.

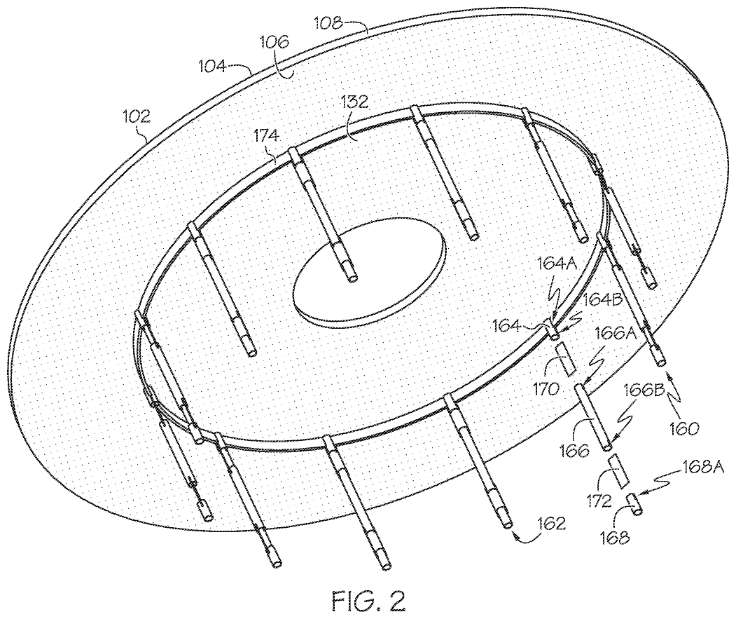

As shown in FIG. 2, the plate 102 may include a bottom surface 106 and outer surface 108. The bottom surface 106 can include a plurality of apertures 130, formed by first aperture portions 132 of the plate 102. The plurality of apertures 130 may be arranged around a catalyst feed conduit passageway 136 in a geometric pattern. The geometric pattern may be different for various applications. For example, the plurality of apertures 130 may be arranged around the catalyst feed conduit passageway 136 in a grid and/or concentrically. The plate 102 can include 10 to 50 apertures 130 per square meter, such as between 20 to 35 apertures per square meter. Other numbers of apertures 130 per square meter are also contemplated.

A ratio of an inside diameter of the first aperture portions 132 of the plate 102 to an inside diameter of the second aperture portions 134 of the plate 102 may be from 0.13 to 0.63, such as from 0.34 to 0.51. A ratio of the inside diameter of the first aperture portions 132 of the plate 102 to the inside diameter of the vessel 110 may be from 0.003 to 0.014, such as from 0.008 to 0.012. A ratio of the inside diameter of the second aperture portions 134 of the plate 102 to the inside diameter of the vessel 110 may be from 0.008 to 0.163, such as from 0.026 to 0.067.

Referring again to FIG. 1, the plate 120 may comprise a deflector plate 140. The deflector plate 140 may be spaced apart from a portion of the bottom surface 106 of the plate 102. The deflector plate 140 may be connected to the bottom surface 106 of the plate 102 by a plurality of deflector plate connectors 142. The deflector plate 140 may deflect and/or reduce a velocity of the gaseous feed entering the vessel 110. The deflection and/or redirection in velocity may cause the gaseous feed to be more evenly distributed through the plurality of apertures 130.

The plate grid distributor 100 may comprise an outer support 150. The outer support 150 may mount and support the plate 102 to the vessel 110 at or near the floor 116 of the vessel 110. The outer support 150 may extend downward at or near an outer periphery of the plate 102. As used in the present disclosure. “an outer periphery of the plate 102” may refer to the outermost (i.e., portion closest to the refractory-lined inner wall 112) 25% of the plate 102, or near that area. An average diameter of the outer support 150 may be greater than an average diameter of the frame 174. The outer support 150 may include a first end 152 and a second end 154. The first end 152 may connected to the floor 116 of the vessel 110. The second end 154 may be connected the plate 102. The first end 152 and the second end 154 may be spaced apart from one another. The space between the first end 152 and the second end 154 may define an outer planar surface 156. The outer planar surface 156 may be spaced apart from an inner planar surface 158. The outer planar surface 156 may be spaced apart from the refractory-lined inner wall 112. The outer planar surface 156 may be connected to a portion of the inner planar surface 158 proximate to the second end 154 and apart from the first end 152. In embodiments, plate grid distributor 100 packing may be disposed between a lower portion of refractory-lined inner wall 112 that is nearer to where the refractory-lined inner wall 112 connects to the floor 116 of the vessel 110 and the outer surface 108 of the plate 102. In embodiments, the outer support 150 may be angled.

Referring to FIGS. 1 and 2, the plate grid distributor 100 for distributing a fluid in a vessel 110 may comprise the internal support system 160. The internal support system 160 may be in direct contact with the bottom surface 106 of the plate 102. The internal support system 160 may comprise a plurality of pillar supports 162 extending substantially vertically from at or near the bottom surface 106 of the plate 102 towards a floor 116 of the vessel 110. As used in the present disclosure. “substantially vertically” may refer to +15 degrees from vertical when system is cool.

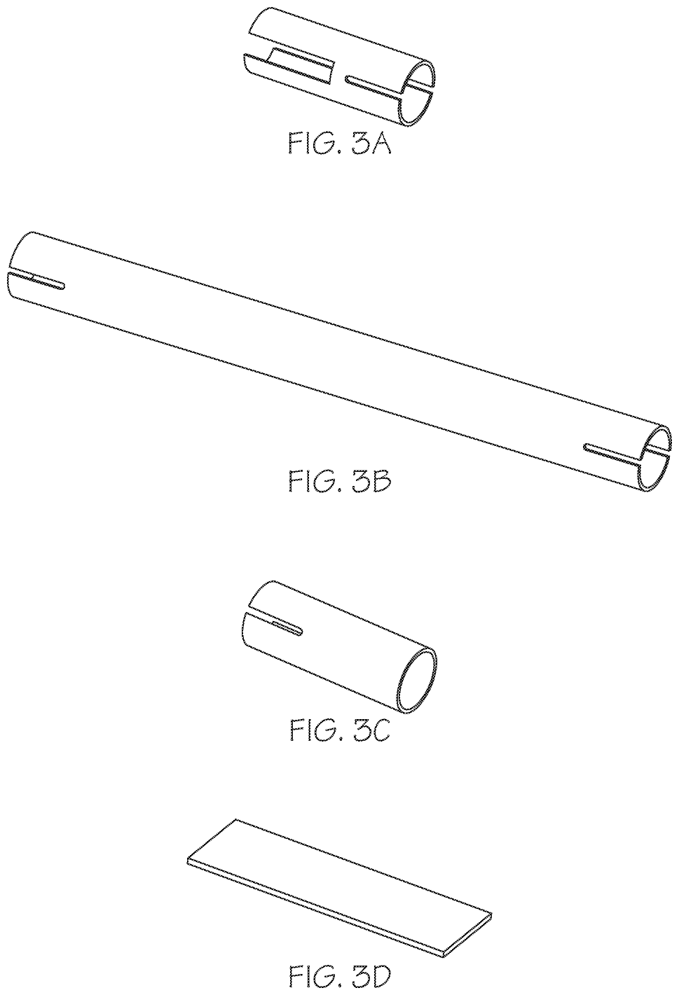

One or more of the pillar supports 162 may comprise a rigid top support bracket 164 (as shown in FIG. 3A), a rigid intermediate beam 166 (as shown in FIG. 3B), and a rigid base support bracket 168 (as shown in FIG. 3C). As used in the present disclosure and in reference to a component. “rigid” may refer to a component that is constructed from materials that are not flexible or are unable to be bent or forced out of shape. The rigid top support bracket 164, the rigid intermediate beam 166, and the rigid base support bracket 168 may be formed from any thermally graded metal or alloy, for example a stainless steel or high nickel alloy. The rigid top support bracket 164, the rigid intermediate beam 166, and the rigid base support bracket 168 may be substantially cylindrical pipes. The rigid top support bracket 164 may be attached to the bottom surface 106 of the plate 102. The rigid base support bracket 168 may be attached to the floor 116 of the vessel 110.

One or more of the pillar supports 162 may comprise a flexible upper member 170 (as shown in FIG. 3D) connecting the rigid top support bracket 164 to the rigid intermediate beam 166 and a flexible lower member 172 (also as shown in FIG. 3D) connecting the rigid intermediate beam 166 to the rigid base support bracket 168. As used in the present disclosure and in reference to a component. “flexible” may refer to a component that is constructed from materials that are capable of bending without breaking and are capable of returning to their original shape after bending. The flexible upper member 170 and the flexible lower member 172 may be formed from any temperature graded metal or allow, such as a stainless steel or high nickel alloy. The flexible upper member 170 and the flexible lower member 172 may have a Young's modulus of less than or equal to 30,000,000 psi at operating temperatures such as 500-800° C., such about 23,000,000 when utilizing 304H stainless steel. The flexible upper member 170 and the flexible lower member 172 may be substantially rectangular plates.

The Young's modulus of the flexible upper member 170 and the flexible lower member 172 may be lower than the Young's modulus of the rigid top support bracket 164, the rigid intermediate beam 166, and the rigid base support bracket 168. As further described in the present disclosure, without being bound to any particular theory, this difference in Young's modulus between the flexible members (e.g., the flexible upper member 170 and the flexible lower member 172) and the rigid members (e.g., the rigid top support bracket 164, the rigid intermediate beam 166, and the rigid base support bracket 168) may allow the one or more of the pillar supports 162 to bend during chemical operations in the vessel 110.

In embodiments, the internal support system 160 may comprise a frame 174. The frame 174 may be in direct contact with the bottom surface 106 of the plate 102. The frame 174 may be attached to the one or more rigid top support brackets 164 of the pillar supports 162. The frame 174 may be continuous or discontinuous. The frame 174 may be the same shape as the plate 102. In embodiments, the frame 174 may comprise a ring shape. The frame 174 may have an average diameter from greater than or equal to 5 feet (1.5 m) to less than or equal to 50 feet (15.2 m), such as from greater than or equal to 10 feet (3.0 m) to less than or equal to 40 feet (12.2 m) or from greater than or equal to 20 feet (6.1 m) to less than or equal to 40 feet (12.2 m). Referring to FIG. 2, the rigid top support bracket 164 may comprise an upper rigid top support bracket notch 164A having a profile complementary to the plate 102, the frame 174, or both. The plate 102, the frame 174, or both may fit into the upper rigid top support bracket notch 164A and attach to the rigid top support bracket 164 via the upper rigid top support bracket notch 164A. The rigid top support bracket 164 may have a lower rigid top support bracket notch 164B having a profile complementary to the flexible upper member 170. The flexible upper member 170 may fit into the lower rigid top support bracket notch 164B and attach to the flexible upper member 170 via the lower rigid top support bracket notch 164B.

The rigid intermediate beam 166 may have an upper rigid intermediate beam notch 166A having a profile complementary to the flexible upper member 170. The flexible upper member 170 may fit into the upper rigid intermediate beam notch 166A and attach to the rigid intermediate beam 166 via the upper rigid intermediate beam notch 166A. The rigid intermediate beam may have a lower rigid top support notch 166B having a profile complementary to the flexible upper member 170. The flexible lower member 172 may fit into the lower rigid intermediate beam notch 166B and attach to the rigid intermediate beam 166 via the lower rigid intermediate beam notch 166B.

The rigid base support bracket 168 may be attached to the floor 116 of the vessel 110. The rigid base support bracket 168 may have an upper rigid base support bracket notch 168A having a profile complementary to the flexible lower member 172. The flexible lower member 172 may fit into the upper rigid base support bracket notch 168A and attach to the rigid support bracket 168 via the upper rigid base support bracket notch 168A.

The flexible upper member 170 and the flexible lower member 172 may be oriented to bend in only one direction. In embodiments, the flexible upper member 170 and the flexible lower member 172 may be oriented to bend only in the outward (i.e., toward the outer surface 108 of the plate 102). The flexible upper member 170 and the flexible lower member 172 may be arranged tangential to the outer surface 108 of the plate 102. The flexible upper member 170 and the flexible lower member 172 may be arranged tangential to the frame 174. Said differently, the flexible upper member 170 and the flexible lower member 172 may be normal to a radius of the plate 102 or to a radius of the frame 174. A face of the flexible upper member 170 and the flexible lower member 172 may face towards the center of the plate 102.

Referring again to FIG. 1, the flexible upper member 170 and flexible lower member 172 may bend when the plate 102 thermally expands or contracts. As chemical processes are operated in the vessel 110, the plate 102 may expand outward due to growth of the plate 102 resulting from reaction conditions within the vessel 110. The internal support system 160 may support the plate 102 and may also bend to continue to support the plate 102 as the plate 102 thermally expands or contracts. The flexible upper member 170 and flexible lower member 172 may allow for the angle from vertical of the rigid intermediate beam 166 to change. The rigid top support bracket 164, the rigid intermediate beam 166, and the rigid base support bracket 168 may provide the necessary strength to continue to support the plate 102 while the flexible upper member 170 and flexible lower member 172 may allow for the angle from vertical of the rigid intermediate 166 beam to change.

It is contemplated that the internal support systems 160 of the present disclosure will be applicable to a multitude of various distributors, such as the plate grid distributors 100 of the present disclosure.

Referring again to FIG. 1, the vessel 110 may include a gaseous feed conduit 123. The gaseous feed conduit 123 may be connected to a gaseous feed conduit receiving passageway 122 that extends through the floor 116 of the vessel 110. The vessel 110 may include a plurality of gaseous feed conduits 123. In embodiments, the plurality of gaseous feed conduits may be connected to a plurality of gaseous feed conduit receiving passageways 122. The plurality of gaseous feed conduit receiving passageways 122 may encircle the longitudinal axis of the vessel 110.

The gaseous feed conduit 123 may be mounted flush with the refractory-lined inner wall 112 or can extend beyond the refractory-lined inner wall 112. A ratio of an inside diameter of the gaseous feed conduit 123 to an inside diameter of the vessel 110 may be from 0.06 to 0.77, such as from 0.20 to 0.23.

Still referring to FIG. 1, the vessel 110 may include a catalyst feed conduit 121. The catalyst feed conduit 121 may be connected to a catalyst feed conduit receiving passageway 120 that extends through the floor 116 of the vessel 110. In embodiments, the vessel 110 may include a plurality of catalyst feed conduits 121. The plurality of catalyst feed conduits 121 may be connected to a plurality of catalyst feed conduit receiving passageways 120. The plurality of catalyst feed conduit receiving passageways 120 may encircle the longitudinal axis of the vessel 110.

The catalyst feed conduit 121 may include a first end 121A and a second end 121B. The catalyst feed conduit 121A may extend through the refractory-lined inner wall 112 and the outer wall 114 of the vessel 110. The second end 121B may be positioned above the top surface 104 of the plate 102. The catalyst feed conduit 121 may extend through the catalyst feed conduit receiving passageway 120 and the catalyst feed conduit passageway 136 such that the second end 121B extends beyond the top surface 104 of the plate 102. A catalyst feed conduit cap 125 may be connected to the second end 121B by one or more connectors 127. The one or more connectors 127 may define gaps 129 through which catalyst can flow into the vessel 110. A ratio of an inside diameter of the catalyst feed conduit 121 to the inside diameter of the vessel 110 may be from 0.08 to 0.23, such as from 0.12 to 0.15.

Still referring to FIG. 1, the plate grid distributor 100 may include a catalyst feed conduit housing 180. The catalyst feed conduit 121 may be slidably housed in the catalyst feed conduit housing 180. The catalyst feed conduit 121 may be spaced apart from an inner surface of the catalyst feed conduit housing 180. The catalyst feed conduit 121 may be slidably housed within the catalyst feed conduit housing 180 to allow for expansion of the catalyst feed conduit 121. For example, the catalyst feed passing through the catalyst feed conduit 121 may be heated, causing the catalyst feed conduit 121 to expand in length and diameter. As such, the catalyst feed conduit 121 can expand, as compared to a vessel 110 where the catalyst feed conduit 121 is welded in place, which may cause a potential for the welds to crack.

The catalyst feed conduit housing 180 may include a first end 180A proximate to the floor 116 of the vessel 110. The catalyst feed conduit housing 180 may include a second end 180B spaced apart from the floor 116 of the vessel 110 and proximate to the top surface 104 of the plate 102. The catalyst feed conduit housing 180 may include an outer surface 181 that is spaced apart from an inner surface 182 of the catalyst feed conduit housing 180. The outer surface 181 of the catalyst feed conduit housing 180 may be connected to an inner circumferential surface of the catalyst feed conduit passageway 136 and to the catalyst feed conduit receiving passageway 120. An inside diameter of the top surface 104 and/or bottom surface 106 may be welded to and/or supported by the catalyst feed conduit housing 180.

Catalyst feed conduit insulation packing may be disposed between the catalyst feed conduit 121 and the inner surface 182 of the catalyst feed conduit housing 180. The catalyst feed conduit insulation packing may help maintain a temperature of a catalyst feed. For example, a temperature of a gaseous feed entering through the gaseous feed conduit 123 may be different than a temperature of a catalyst feed entering through the catalyst feed conduit 121. For instance, where certain reactions are being performed in the vessel 110, a gaseous feed can enter through the gaseous feed conduit 123 at from 25 degrees Celsius (° C.) to 700° C., and a catalyst may enter the catalyst feed conduit 121 at 600° C., to 900° C. As such, if the gaseous feed contacts the catalyst feed conduit 121, which may be heated to 600° C., to 900° C., as a result of the catalyst flowing through it, the gaseous feed may begin to coke and cause the vessel 110 and/or plate grid distributor 100 to plug.

In embodiments, the catalyst feed conduit 121 may comprise a catalyst backflow diverter 184. The catalyst backflow diverter 184 may be connected to the catalyst feed conduit 121 proximate to the second end 121B of the catalyst feed conduit 121 above the top surface 104 of the plate 102. The catalyst backflow diverter 182 may extend from the catalyst feed conduit 121 and extends beyond the second end 180B of the catalyst feed conduit housing 180. The catalyst backflow diverter 182 may reduce catalyst introduction into the catalyst feed conduit insulation packing.

Referring again to FIG. 1, the present disclosure is also directed toward methods of distributing a fluid through a plate grid distributor 100 in a vessel 110. A method of distributing a fluid through a plate grid distributor 100 in a vessel 110 may include passing the fluid into the vessel 110 at reaction conditions through a fluid inlet below the plate grid distributor 100 and directing the fluid through the plate gird distributor 100.

As previously discussed in the present disclosure, the plate gird distributor 100 may comprise a plate 102 comprising a plurality of apertures 130. The plate 102 may comprise a top surface 104 and a bottom surface 106 opposite the top surface 104. The plate gird distributor 100 may comprise an internal support system in contact with the bottom surface 106 of the plate. The internal support system may comprise a plurality of pillar supports 162 extending substantially vertically from at or near the bottom surface 106 of the plate 102 towards a floor 116 of the vessel 110. One or more of the pillar supports 162 may comprise a rigid top support bracket 164, a rigid intermediate beam 166, a rigid base support bracket 168 attached to the floor 116 of the vessel 110, a flexible upper member 170 connecting the rigid top support bracket 164 to the rigid intermediate beam 166, and a flexible lower member 172 connecting the rigid intermediate beam 166 to the rigid base support bracket 168. Also as previously discussed in the present disclosure, the flexible upper member 170 and flexible lower member may bend when the plate 102 thermally expands or contracts allowing for the angle from vertical of the rigid intermediate beam 166 to change.

The plate gird distributor 100 may have any of the features previously discussed in this disclosure for the plate gird distributor 100.

During operation of the vessel, the floor 116 of the vessel 110 may be at a lower temperature than upper portions of the vessel, such as at the plate 102 of the plate grid distributor 100. In embodiments, the floor 116 of the vessel 110 may be at temperature ranging from greater than or equal to 100° C., to less than or equal to 200° C. during operation. The plate 102 of the plate grid distributor 100 may be at temperature ranging from greater than or equal to 500° C., to less than or equal to 700° C. during operation. A temperature differential between the floor 116 of the vessel 110 and the plate 102 of the plate gird distributor may be at least 100° C. during operation.

The plate 102 of the plate grid distributor 102 may have a coefficient of thermal expansion that is greater than the floor 116 of the vessel 110. Accordingly, due to the greater coefficient of thermal expansion and higher temperature during operation, an amount of expansion at the plate 102 may be greater than at the floor 116. As previously described in the present disclosure, the one or more pillar supports 162 of the internal support system 160 may bend to continue supporting the plate grid distributor 100 as the plate 102 expands outward during operation.

One or more aspect of the present disclosure are described herein. A first aspect may include a plate grid distributor for distributing a fluid in a vessel, the plate grid distributor comprising a plate comprising a plurality of apertures, wherein the plate comprises a top surface and a bottom surface opposite the top surface; and an internal support system in direct contact with the bottom surface of the plate, the internal support system comprising a plurality of pillar supports extending substantially vertically from at or near the bottom surface of the plate towards a floor of the vessel, and wherein one or more of the pillar supports comprise: a rigid top support bracket; a rigid intermediate beam; a rigid base support bracket attached to the floor of the vessel; a flexible upper member connecting the rigid top support bracket to the rigid intermediate beam; and a flexible lower member connecting the rigid intermediate beam to the rigid base support; and wherein the flexible upper member and flexible lower member 172 bend when the plate thermally expands or contracts allowing for the angle from vertical of the rigid intermediate beam to change.

A second aspect of the present disclosure may include the first aspect, wherein the internal support system further comprises a frame that is in direct contact with the bottom surface of the plate, and wherein the frame is attached to the one or more rigid top support brackets of the pillar supports.

A third aspect of the present disclosure may include the second aspect, wherein the frame comprises a ring shape.

A fourth aspect of the present disclosure may include either the second or third aspect, wherein the frame is continuous.

A fifth aspect of the present disclosure may include any one of the first through fourth aspects, wherein the plate is substantially planar.

A sixth aspect of the present disclosure may include any one of the first through fifth aspects, wherein the rigid top support bracket comprises: an upper rigid top support bracket notch having a profile complementary to the plate, the frame, or both; and a lower rigid top support bracket notch having a profile complementary to the flexible upper member.

A seventh aspect of the present disclosure may include any one of the first through sixth aspects, wherein the rigid intermediate beam comprises: an upper rigid intermediate beam notch having a profile complementary to the flexible upper member; and a lower rigid intermediate beam notch having a profile complementary to the flexible lower member.

An eighth aspect of the present disclosure may include any one of the first through seventh aspects, wherein the rigid base support bracket comprises: an upper rigid base support bracket notch having a profile complementary to the flexible lower member.

A ninth aspect of the present disclosure may include any one of the first through eighth aspects, wherein the plate comprises an average diameter of greater than or equal to 5 feet (1.5 m) to less than or equal to 75 feet (22.9 m).

A tenth aspect of the present disclosure may include any one of the first through ninth aspects, wherein the frame comprises an average diameter of greater than or equal to 5 feet (1.5 meters) to less than or equal to 50 feet (15.2 meters).

An eleventh aspect of the present disclosure may include any one of the first through tenth aspects, further comprising an outer support extending downward from at or near an outer periphery of the plate.

A twelfth aspect of the present disclosure may include the eleventh aspect, wherein the outer support is angled.

A thirteenth aspect of the present disclosure may include the eleventh aspect, wherein an average diameter of the outer support is greater than an average diameter of the frame.

A fourteenth aspect of the present disclosure may include any one of the first through thirteenth aspects, further comprising a refractory material in direct contact with and covering substantially all of an upper surface of the plate.

A fifteenth aspect of the present disclosure may include a method of distributing a fluid through a plate grid distributor in a vessel, the method comprising: passing the fluid into the vessel at reaction conditions through a fluid inlet below the plate grid distributor; and directing the fluid through the plate gird distributor, the plate grid distributor comprising: a plate comprising a plurality of apertures, wherein the plate comprises a top surface and a bottom surface opposite the top surface; an internal support system in contact with the bottom surface of the plate, the internal support system comprising a plurality of pillar supports extending substantially vertically from at or near the bottom surface of the plate towards a floor of the vessel, and wherein one or more of the pillar supports comprise: a rigid top support bracket; a rigid intermediate beam; a rigid base support bracket attached to the floor of the vessel; a flexible upper member connecting the rigid top support bracket to the rigid intermediate beam; and a flexible lower member connecting the rigid intermediate beam to the rigid base support; and wherein the flexible upper member and flexible lower member bend when the plate thermally expands or contracts allowing for the angle from vertical of the rigid intermediate beam to change.

Finally, it will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A plate grid distributor for distributing a fluid in a vessel, the plate grid distributor comprising:
a plate comprising a plurality of apertures, a top surface, and a bottom surface opposite the top surface; and
an internal support system in direct contact with the bottom surface of the plate, the internal support system comprising a plurality of pillar supports extending substantially vertically from at or near the bottom surface of the plate towards a floor of the vessel, and wherein one or more of the pillar supports comprise:
a rigid top support bracket;
a rigid intermediate beam;
a rigid base support bracket attached to the floor of the vessel;
a flexible upper member connecting the rigid top support bracket to the rigid intermediate beam; and
a flexible lower member connecting the rigid intermediate beam to the rigid base support; and
wherein the flexible upper member and flexible lower member bend when the plate thermally expands or contracts allowing for the angle from vertical of the rigid intermediate beam to change.

2. The plate grid distributor of claim 1, wherein the internal support system further comprises a frame that is in direct contact with the bottom surface of the plate, and wherein the frame is attached to the one or more rigid top support brackets of the pillar supports.

3. The plate grid distributor of claim 2, wherein the frame comprises a ring shape.

4. The plate grid distributor of claim 2, wherein the frame is continuous.

5. The plate grid distributor of claim 1, wherein the plate is substantially planar.

6. The plate grid distributor of claim 1, wherein the rigid top support bracket comprises:
an upper rigid top support bracket notch having a profile complementary to the plate, the frame, or both; and
a lower rigid top support bracket notch having a profile complementary to the flexible upper member.

7. The plate grid distributor of claim 1, wherein the rigid intermediate beam comprises:
an upper rigid intermediate beam notch having a profile complementary to the flexible upper member; and
a lower rigid intermediate beam notch having a profile complementary to the flexible lower member.

8. The plate grid distributor of claim 1, wherein the rigid base support bracket comprises:
an upper rigid base support bracket notch having a profile complementary to the flexible lower member.

9. The plate grid distributor of claim 1, wherein the plate comprises an average diameter of greater than or equal to 5 feet (1.5 m) to less than or equal to 75 feet (22.9 m).

10. The plate grid distributor of claim 1, wherein the frame comprises an average diameter of greater than or equal to 5 feet (1.5 m) to less than or equal to 50 feet (15.2 m).

11. The plate grid distributor of claim 1, further comprising an outer support extending downward from at or near an outer periphery of the plate.

12. The plate grid distributor of claim 11, wherein the outer support is angled.

13. The plate grid distributor of claim 11, wherein an average diameter of the outer support is greater than an average diameter of the frame.

14. The plate grid distributor of claim 1, further comprising a refractory material in direct contact with and covering substantially all of an upper surface of the plate.

15. A method of distributing a fluid through a plate grid distributor in a vessel, the method comprising:
passing the fluid into the vessel at reaction conditions through a fluid inlet below the plate grid distributor; and
directing the fluid through the plate gird distributor, the plate grid distributor comprising:
a plate comprising a plurality of apertures, wherein the plate comprises a top surface and a bottom surface opposite the top surface;
an internal support system in contact with the bottom surface of the plate, the internal support system comprising a plurality of pillar supports extending substantially vertically from at or near the bottom surface of the plate towards a floor of the vessel, and wherein one or more of the pillar supports comprise:
a rigid top support bracket;
a rigid intermediate beam;
a rigid base support bracket attached to the floor of the vessel;
a flexible upper member connecting the rigid top support bracket to the rigid intermediate beam; and
a flexible lower member connecting the rigid intermediate beam to the rigid base support; and
wherein the flexible upper member and flexible lower member bend when the plate thermally expands or contracts allowing for the angle from vertical of the rigid intermediate beam to change.
